(19) United States
(12) Patent Application Publication
(10) Pub. No.: US 2009/0225469 A1
(43) Pub. Date: Sep. 10, 2009

(54) METHOD OF MANUFACTURING A DRIVE APPARATUS, CONNECTION CIRCUIT BOARD, AND DRIVE APPARATUS USING THE SAME

(75) Inventor: Yoshikazu Yamazaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/245,369

(22) Filed: Oct. 3, 2008

(30) Foreign Application Priority Data
Mar. 6, 2008 (JP) 2008-055758

(51) Int. Cl. G11B 5/012; G11B 5/127; H01R 31/00

(52) U.S. Cl. 360/97.01; 29/603.03; G9B/5.024

(57) ABSTRACT

A method of manufacturing a drive apparatus electrically connects a motor and a control circuit board for the motor without causing poor connections. When manufacturing a drive apparatus that rotationally drives a recording medium using a motor, the motor, which is connected in advance to one end of a connection circuit board that connects the motor and a control circuit board for the motor, is attached to a drive apparatus case and then the other end of the connection circuit board is connected to the control circuit board for the motor.

### BACKGROUND OF THE INVENTION

The present invention relates to a method of manufacturing a drive apparatus that rotationally drives a recording medium using a motor, a connection circuit board that connects a motor for rotationally driving a recording medium and a control circuit board for the motor, and a drive apparatus that rotationally drives a recording medium using a motor.

Data can be written onto and read from a recording medium such as a magnetic disk, an optical disc, or a magneto-optical disc by a drive apparatus that rotationally drives the recording medium using a motor. A DC brushless motor or the like is normally used as the motor.

The overall construction of a conventional drive apparatus is shown in FIG. 7.

In the case of a hard disk apparatus, for example, a motor 5 for rotationally driving a magnetic disk 2 is assembled inside a case 6 and then the motor 5 and a control circuit board 7 are connected.

Note that an attachment hole 8 is formed in the case 6 at the position where the motor 5 is assembled, and an upper end portion 5a of the motor 5 is disposed so as to protrude out of the attachment hole 8.

A connection portion for electrically connecting the motor 5 is provided at the upper end portion 5a of the motor 5.

A plane view of the connection portion is shown in FIG. 8 and a partial cross-sectional view of the motor is shown in FIG. 9.

Hereinafter this connection portion is referred to as the “motor FPC (Flexible Printed Circuit) 10”. The motor FPC 10 is a member that is provided so that tests can be carried out by the motor manufacturer who manufactures the motor before the motor is shipped (see for example, Japanese Laid-Open Patent Publication No. 2001-190056).

The motor FPC 10 includes a plurality of pads 12 that are respectively electrically connected to driving coils 11 of the motor 5. The surfaces of the pads 12 are formed of solder and are connected to the driving coils 11 by printed circuits 13. The pads 12 are exposed at the upper end portion 5a of the motor 5, and connection parts 19 where the pads 12 are connected to the driving coils 11 by the printed circuits 13 are provided at positions that are not exposed to the outside of the motor.

The pads 12 are formed at predetermined intervals around the upper end portion 5a of the motor 5 and are formed so as to facilitate electrically connecting the pads 12 and carrying out tests before the motor is shipped.

After the motor 5 has been attached to the case 6, the motor 5 is connected to the control circuit board 7. The motor 5 and the control circuit board 7 are connected by an FPC (Flexible Printed Circuit) 14 as one example of a connection circuit board.

The form of the motor end of the FPC 14 is shown in FIG. 10.

A connection portion 14a in the form of a flat plate is formed at the motor end of the FPC 14. A plurality of pads 15 that can be connected by soldering to the motor FPC 10 are formed on the connection portion 14a.

Note that a connector 16 is provided at the control circuit board 7 end of the FPC 14 and is connected to a connector 17 provided on the control circuit board 7.

Note that in the past, there have also been cases where the motor 5 and the FPC 14 are connected using connectors. However, compared to the demands for miniaturization and reduced thickness for hard disc apparatuses, the size in the height direction becomes too large when connectors are used. Instead, as shown in the drawings the plate-like connection portion 14a of the FPC 14 and the motor FPC 10 that is connected in advance by the motor manufacturer are placed on top of one another and connected.

The plate-like connection portion 14a that is formed at the motor end of the FPC 14 has a plurality of pads 15 that are formed of solder at the same positions as the pads 12 formed on the motor FPC 10. The pads 15 of the FPC 14 are connected by printed circuits 18 so as to be connected to the corresponding terminals on the connector 16 at the other end.

When the FPC 14 and the motor 5 of the construction described above are connected, the plate-like connection portion 14a of the FPC 14 is placed on and connected to the motor FPC 10 of the motor 5 by fixing the pads with solder.

### SUMMARY OF THE INVENTION

As described above, with a method where an FPC is soldered after a motor has been assembled in a drive apparatus case to connect the motor and the FPC, there is the problem that the soldering operation is difficult, leading to the risk of operation errors.

Solder webbing and solder bridges can be given as examples of poor connections produced by operation errors. When such poor connections are produced, there is the risk of fire or smoking due to improper insulation or an insufficient withstand voltage.

The present invention was conceived in view of the problem described above, and it is an object of the present invention to provide a method of manufacturing a drive apparatus that can manufacture a drive apparatus without producing poor connections when electrically connecting a motor and a control circuit board for the motor, and to also provide a connection circuit board and a drive apparatus that uses the same.

A method of manufacturing a drive apparatus according to the present invention manufactures a drive apparatus that rotationally drives a recording medium using a motor, the method including steps of: attaching a motor, which has been connected in advance to one end of a connection circuit board that connects the motor and a control circuit board for the motor, to a drive apparatus case; and then connecting another end of the connection circuit board to the control circuit board for the motor.

According to this method, since it is not necessary to connect the connection circuit board by soldering to the motor that has been assembled on the drive apparatus case, it is possible to reduce operation errors and to reduce the number of poor connections.

The connection circuit board may be formed in a folded-up state in advance, and after the motor that has been connected to the connection circuit board in the folded-up state is attached to the drive apparatus case, the connection circuit board may be unfolded and the other end of the connection circuit board connected to the control circuit board for the motor.

Here, there is the risk that the connection circuit board will get in the way if the motor is assembled in an attachment hole in the case with the connection circuit board having already been connected to the motor. However, by folding up the connection circuit board, the connection circuit board is prevented from getting in the way and it becomes possible to easily attach the motor to the attachment hole of the case.

Also, when the motor that has been connected to one end of the connection circuit board in the folded-up state is attached to the drive apparatus case, an upper part of the connection circuit board in the folded-up state may be covered by a cover member so that the connection circuit board in the folded-up state does not become unfolded.

According to this method, it is possible to prevent the connection circuit board from becoming unfolded and getting in the way.

Note that when the other end of the connection circuit board is connected to the control circuit board for the motor, the cover member may be removed to unfold the folded-up connection circuit board.

Also, the connection circuit board may be formed so as to be folded up in a normal state.

A connection circuit board according to the present invention connects a motor that rotationally drives a recording medium and a control circuit board for the motor, wherein the connection circuit board is constructed so that wires provided at one end of the connection circuit board are capable of being electrically connected to driving coils inside the motor, wires provided at another end of the connection circuit board are capable of being electrically connected to the control circuit board, and pads capable of being electrically connected to outside the wires are provided on the respective wires connected to the driving coils.

According to this construction, since it is possible to connect the connection circuit board in advance during the manufacturing of a motor, it is no longer necessary to connect the connection circuit board after the motor has been assembled on the drive apparatus case.

The connection circuit board may be capable of being folded, and the connection circuit board may be formed so as to be folded up in a normal state.

A drive apparatus according to the present invention includes: a motor that rotates a recording medium; and the connection circuit board described above that connects the motor to a control circuit board for the motor.

Here, the other end of the connection circuit board may be provided so as to be detachably attached to the control circuit board, and a cover member that covers an upper part of the connection circuit board in a folded-up state may be provided on the motor so that when the other end of the connection circuit board is not attached to the control circuit board, the connection circuit board in the folded-up state on the motor does not become unfolded.

According to the method of manufacturing a drive apparatus, the connection circuit board, and the drive apparatus according to the present invention, it is possible to reduce operation errors and to reduce the number of poor connections.

### BRIEF DESCRIPTION OF THE DRAWINGS

FIG. 1 is a perspective view showing the overall construction of a drive apparatus according to the present invention;

FIG. 2 is a cross-sectional view of a motor attachment part of the drive apparatus shown in FIG. 1;

FIG. 3 is a plane view of a connection circuit board according to the present invention;

FIG. 4 is a partial cross-sectional view of a motor;

FIG. 5 is a cross-sectional view of a motor attachment part of the drive apparatus showing a state where the connection circuit board is folded up;

FIG. 6 is a flowchart useful in explaining a method of manufacturing a drive apparatus according to the present invention;

FIG. 7 is a perspective view showing the overall construction of a conventional drive apparatus;

FIG. 8 is a diagram useful in explaining a conventional connection portion of a motor;

FIG. 9 is a partial cross-sectional view of a conventional motor; and

FIG. 10 is a plane view of a motor end of a conventional connection circuit board.

### DESCRIPTION OF THE PREFERRED EMBODIMENTS

Preferred embodiments of a drive apparatus, a connection circuit board, and a method of manufacturing the same will now be described.

A hard disk apparatus is one example of a drive apparatus according to an embodiment of the present invention. In the case of a hard disk apparatus, a magnetic disk is used as the recording medium.

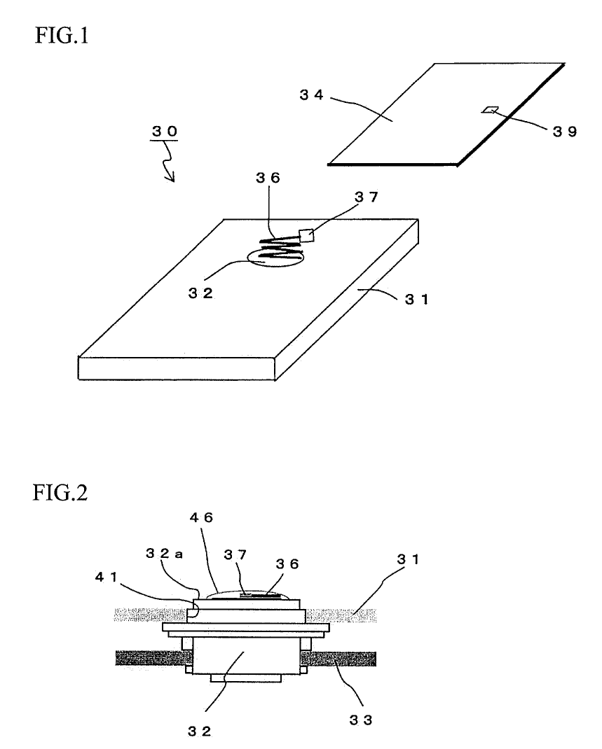

FIG. 1 is a perspective view showing the overall construction of a hard disk apparatus. FIG. 2 is a cross-sectional view showing a part of a case where a motor is attached.

The hard disk apparatus 30 includes, inside an apparatus case 31, a magnetic disk 33, a carriage arm that includes a head slider at a front end thereof, and a spindle motor 32 that rotationally drives the magnetic disk 33. Here, a DC brushless motor is normally used as the spindle motor (hereinafter simply “motor”) 32 that rotationally drives the magnetic disk 33.

The hard disk apparatus 30 is constructed by assembling the magnetic disk 33, the carriage arm, and the spindle motor 32 mentioned above inside the apparatus case 31 (hereinafter simply “case”).

After these components have been assembled inside the case 31, the motor 32 and a control circuit board 34 are electrically connected. Here, the motor 32 and the control circuit board 34 are connected by a connection circuit board 36.

A control circuit (that includes a controller IC or the like) that controls the driving current flowing to the motor 32 and also a control circuit that controls the entire hard disk apparatus 30 are formed on the control circuit board 34.

Note that the connection circuit board 36 for connecting the control circuit board 34 to the motor 32 is provided so as to be connected in advance to the motor 32 during the manufacturing of the motor 32.

An attachment hole 41 for the motor 32 is formed in the case 31 and the motor 32 is attached so that an upper end portion 32a thereof protrudes out of the case 31 from the attachment hole 41.

The connection circuit board 36 is provided on the upper end portion 32a of the motor 32.

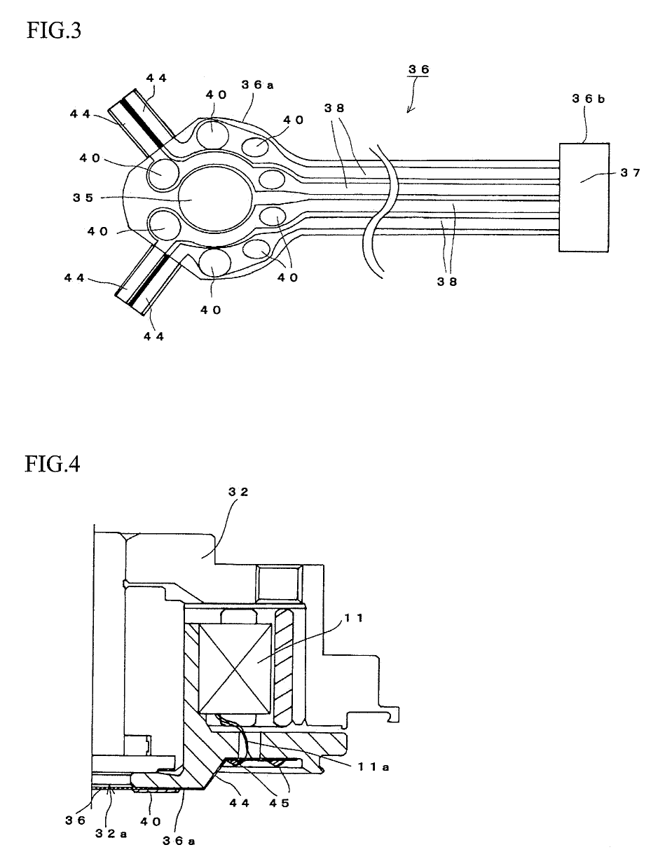

The connection circuit board 36 will now be described in detail with reference to FIGS. 3 and 4.

As one example of the connection circuit board 36, an FPC (Flexible Printed Circuit) where copper foil is formed as wires inside a covering made of polyimide is used. Hereinafter, the connection circuit board 36 is simply referred to as the “FPC 36”.

One end of the FPC 36 is connected to the motor 32 and the other end of the FPC 36 is connected to the control circuit board 34.

Printed circuits 38 that are connected to both the driving coils inside the motor 32 and the terminals of the connector are formed along the entire length of the FPC 36.

One end 36a of the FPC 36 is formed in a shape that matches the shape of the upper end portion 32a of the motor 32 and is flatly disposed on the upper end portion 32a of the motor 32. A through-hole 35 through which a rotational shaft portion of the motor 32 is passed is formed in the center of the end 36a.

In addition, a plurality of wiring portions 44 that can be connected by direct soldering or the like to electrically connect the driving coils 11 inside the motor 32 and the printed circuits 38 are formed so as to protrude outward at the end 36a. However, the wiring portions 44 are disposed so as to be bent when the FPC 36 is connected to the motor 32, so that connections 45 between terminals 11a that extend out from the driving coils 11 and the wiring portions 44 are not visible from outside the motor 32.

Note that a connector 37 is connected to the other end 36b of the FPC 36. The connector 37 can be connected to a connector 39 provided on the control circuit board 34. Accordingly, a one-touch connection can be made between the other end 36b of the FPC 36 and the control circuit board 34 using the connectors 37 and 39.

A plurality of pads 40, which make it possible to electrically connect the printed circuits 38 that are connected to the driving coils 11 on the outside of the motor, are formed on the end 36a of the FPC 36. The pads 40 are formed of metal such as solder and are formed so as to be substantially circular in shape. By forming these pads 40, during the manufacturing stage of the motor 32, it is possible to test the motor before shipping by connecting (or touching) a testing apparatus or the like to the pads 40.

Note that there is the risk that the FPC 36 will get in the way and make assembly difficult if the motor 32 is assembled in the case 31 with the FPC 36 having already been connected. This is because the motor 32 is assembled in the case 31 by forming the attachment hole 41 in the case 31 in advance and inserting the motor 32 into the attachment hole 41 using an automated device.

For this reason, the FPC 36 that is connected to the motor 32 is provided so as to be foldable so that the FPC 36 can be folded and made compact when the motor 32 is assembled in the case 31.

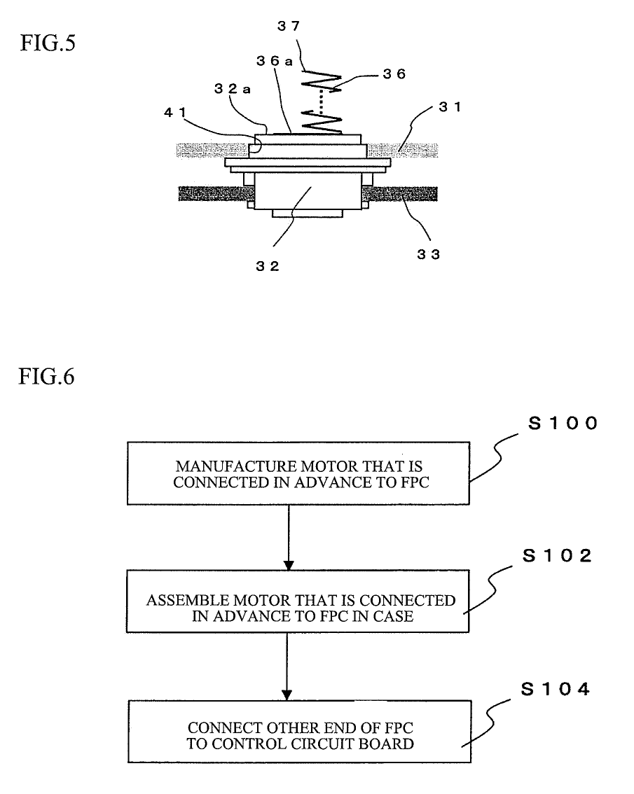

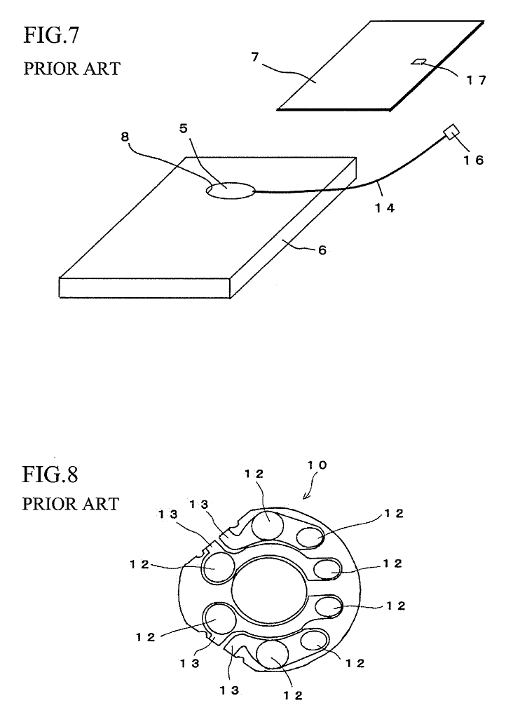

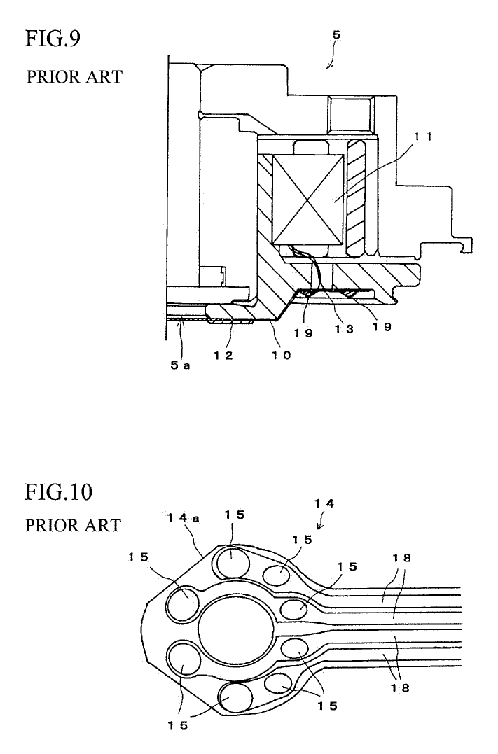

As the method of folding, the FPC 36 may be formed in a zigzag form as shown in FIG. 5.

As the method of folding the FPC 36, instead of folding up the FPC 36 after the FPC 36 has been formed, the FPC 36 may instead be formed in advance in a folding state. By using an FPC 36 that is foldable in advance, it is possible to keep the FPC 36 folded up in the normal state and to extend the FPC 36 as necessary by pulling upon the FPC 36.

A fixed cover 46 (that corresponds to a “cover means” in the patent claims) that covers the folded FPC 36 from above may be provided on the upper end portion 32a of the motor 32.

The fixed cover 46 is formed of composite resin or the like and functions so as to press down the folded-up FPC 36 and thereby prevent the FPC 36 from extending. Since the fixed cover 46 needs to be removed when the FPC 36 is connected to the control circuit board 34, the fixed cover 46 may be detachably provided on the upper end portion 32a of the motor 32 using adhesive tape or the like. To attach the fixed cover 46 to the upper end portion 32a of the motor 32, it is also possible to form the front end of the fixed cover 46 as a hook and to detachably engage this hook-shaped part on the edge of the upper end portion 32a of the motor 32 (not shown).

Note that even if the fixed cover 46 is not provided above the FPC 36, it is possible to use a construction where the FPC 36 itself prevents the FPC 36 from becoming unfolded.

For example, the connector 37 that is connected to the other end of the FPC 36 may be used. In this example, by forming a first locking mechanism that engages a second locking mechanism formed in advance on the connector 37 on the FPC 36, it is possible to engage the first and second locking mechanisms of the connector 37 and the FPC 36 in a state where the FPC 36 is folded up (not shown).

With this construction, since it is not necessary to provide the fixed cover 46, there is the effect that it is possible to reduce the number of parts compared to the example where the fixed cover 46 is provided.

Next, a method of manufacturing the motor that uses the FPC described above will be described.

FIG. 6 is a flowchart useful in explaining a method of manufacturing a hard disk drive according to the present invention.

First, during manufacturing of the motor, the motor manufacturer connects one end of the FPC 36, which has been folded up in the zigzag manner described above to the motor (step S100). At this time, the fixed cover 46 is attached so as to prevent the FPC 36 from becoming unfolded.

Next, at the manufacturer of the hard disk apparatus 30, the motor 32 to which the FPC 36 has been connected in advance is assembled in the case 31 (step S102). Such assembling is carried out by using an automatic apparatus to insert the motor 32 into the attachment hole 41 formed in the case 31 so that the upper end portion 32a of the motor 32 protrudes outward.

After this, the fixed cover 46 is peeled off and the folded-up FPC 36 is pulled so as to extend. The connector 37 at the other end 36b of the extended FPC 36 is connected to the connector 39 of the control circuit board 34 (step S104).

By doing so, the manufacturing of the hard disk apparatus is completed.

Note that in the embodiment described above, a hard disk apparatus has been described as an example of a drive apparatus.

However, a drive apparatus that rotationally drives a recording medium according to the present invention is not limited to a hard disk apparatus and it is possible to apply the present invention to a variety of drive apparatuses such as a CD drive, a DVD drive, an MO drive, and a floppy (registered trademark) disk drive.

What is claimed is:

1. A method of manufacturing a drive apparatus that rotationally drives a recording medium using a motor, comprising steps of:
attaching a motor, which has been connected in advance to one end of a connection circuit board that connects the motor and a control circuit board for the motor, to a drive apparatus case; and
then connecting another end of the connection circuit board to the control circuit board for the motor.

2. A method of manufacturing a drive apparatus according to claim 1,
wherein the connection circuit board is formed in a folded-up state in advance, and
after the motor that has been connected to the connection circuit board in the folded-up state is attached to the drive apparatus case,
the connection circuit board is unfolded and the other end of the connection circuit board is connected to the control circuit board for the motor.

3. A method of manufacturing a drive apparatus according to claim 2,
wherein when the motor that has been connected to one end of the connection circuit board in the folded-up state is attached to the drive apparatus case, an upper part of the connection circuit board in the folded-up state is covered by a cover member so that the connection circuit board in the folded-up state does not become unfolded.

4. A method of manufacturing a drive apparatus according to claim 3,
wherein when the other end of the connection circuit board is connected to the control circuit board for the motor, the cover member is removed to unfold the folded-up connection circuit board.

5. A method of manufacturing a drive apparatus according to claim 2,
wherein the connection circuit board is formed so as to be folded up in a normal state.

6. A method of manufacturing a drive apparatus according to claim 3,
wherein the connection circuit board is formed so as to be folded up in a normal state.

7. A method of manufacturing a drive apparatus according to claim 4,
wherein the connection circuit board is formed so as to be folded up in a normal state.

8. A connection circuit board that connects a motor that rotationally drives a recording medium and a control circuit board for the motor,
wherein the connection circuit board is constructed so that wires provided at one end of the connection circuit board are capable of being electrically connected to driving coils inside the motor,
wires provided at another end of the connection circuit board are capable of being electrically connected to the control circuit board, and
pads capable of being electrically connected to outside the wires are provided on the respective wires connected to the driving coils.

9. A connection circuit board according to claim 8,
wherein the connection circuit board is capable of being folded.

10. A connection circuit board according to claim 9,
wherein the connection circuit board is formed so as to be folded up in a normal state.

11. A drive apparatus comprising:
a motor that rotates a recording medium; and
a connection circuit board according to claim 8 that connects the motor to a control circuit board for the motor.

12. A drive apparatus comprising:
a motor that rotates a recording medium; and
a connection circuit board according to claim 9 that connects the motor to a control circuit board for the motor.

13. A drive apparatus comprising:
a motor that rotates a recording medium; and
a connection circuit board according to claim 10 that connects the motor to a control circuit board for the motor.

14. A drive apparatus according to claim 11,
wherein the other end of the connection circuit board is provided so as to be detachably attached to the control circuit board, and
a cover member that covers an upper part of the connection circuit board in a folded-up state is provided on the motor so that when the other end of the connection circuit board is not attached to the control circuit board, the connection circuit board in the folded-up state on the motor does not become unfolded.

15. A drive apparatus according to claim 12,
wherein the other end of the connection circuit board is provided so as to be detachably attached to the control circuit board, and
a cover member that covers an upper part of the connection circuit board in a folded-up state is provided on the motor so that when the other end of the connection circuit board is not attached to the control circuit board, the connection circuit board in the folded-up state on the motor does not become unfolded.

16. A drive apparatus according to claim 13,
wherein the other end of the connection circuit board is provided so as to be detachably attached to the control circuit board, and
a cover member that covers an upper part of the connection circuit board in a folded-up state is provided on the motor so that when the other end of the connection circuit board is not attached to the control circuit board, the connection circuit board in the folded-up state on the motor does not become unfolded.
